(19) United States
(12) Patent Application Publication
(10) Pub. No.: US 2014/0376459 A1
(43) Pub. Date: Dec. 25, 2014

(54) AGGREGATING DATA TO IMPROVE PERFORMANCE AT A USER EQUIPMENT (UE)

(71) Applicant: QUALCOMM Incorporated, San Diego, CA (US)

(72) Inventors: Sitaramanjaneyulu KANAMARLAPUDI, San Diego, CA (US); Liangchi HSU, San Diego, CA (US); Rohit KAPOOR, San Diego, CA (US); Venkata Ramanan VENKATACHALAM JAYARAMAN, Del Mar, CA (US); Rashid Ahmed Abkar ATTAR, San Diego, CA (US); Harish VENKATACHARI, Sunnyvale, CA (US)

(21) Appl. No.: 14/305,844

(22) Filed: Jun. 16, 2014

Related U.S. Application Data
(60) Provisional application No. 61/837,725, filed on Jun. 21, 2013.

(51) Int. Cl. H04W 72/04

(52) U.S. Cl. CPC H04W 72/0413; H04W 72/04
USPC 370/329

(57) ABSTRACT

The present disclosure presents a method and an apparatus for improving power performance at a user equipment (UE). For example, the method may include aggregating data at the UE for transmitting on a uplink (UL) from the UE to a base station communicating with the UE until a data aggregation condition is satisfied, determining when the data aggregation condition is satisfied at the UE, wherein the data aggregation condition includes at least a buffer occupancy condition or a delay transmission timer, and requesting resources from the base station for transmitting the data on the UL in response to determining that the data aggregation condition is satisfied. As such, improved performance at a UE is achieved.

### CLAIM OF PRIORITY

The present application for patent claims priority to U.S. Provisional Patent Application No. 61/837,725, filed Jun. 21, 2013, entitled “Method and Apparatus for Aggregating Data to Improve Signaling and Power Performance,” which is assigned to the assignee hereof, and hereby expressly incorporated by reference herein.

### BACKGROUND

Aspects of the present disclosure relate generally to wireless communication systems, and more particularly, to aggregating data for improving performance at a user equipment (UE).

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

In a wireless network, when a user equipment (UE) has to transmit data on a uplink (UL) from the UE to a base station, the UE goes through a series of state transitions prior to transmitting the data. The UE goes through the state transitions without taking into consideration the amount of data for transmitting to the base station. That is, the UE may go through the state transitions for 50 bytes or 1 MB of data. In a scenario, where the UE has to transmit small amounts of data in a periodic manner (e.g., periodic small data bursts), the UE will go through the state transitions every time the UE has to transmit data. This will result in unnecessary signaling overhead at the UE and/or the base station, and is not power efficient at the UE.

Therefore, there is a desire for a method and an apparatus for aggregating data to improve performance at a user equipment.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure presents an example method and apparatus for improving performance at a user equipment (UE). For example, the present disclosure presents an example method for improving performance at a UE that may include aggregating data at the UE for transmitting on a uplink (UL) from the UE to a base station communicating with the UE until a data aggregation condition is satisfied, determining when the data aggregation condition is satisfied at the UE, wherein the data aggregation condition includes at least a buffer occupancy condition or a delay transmission timer, and requesting resources from the base station for transmitting the data on the UL in response to determining that the data aggregation condition is satisfied.

Additionally, the present disclosure presents an example apparatus for improving performance at a UE that may include means for aggregating data at the UE for transmitting on a uplink (UL) from the UE to a base station communicating with the UE until a data aggregation condition is satisfied, means for determining when a data aggregation condition is satisfied at the UE, wherein the data aggregation condition includes at least a buffer occupancy condition or a delay transmission timer, and means for requesting resources from the base station for transmitting the data on the UL in response to determining that the data aggregation condition is satisfied.

In a further aspect, the presents disclosure presents an example non-transitory computer readable medium for improving performance at a UE comprising code that, when executed by a processor or processing system included within the UE, causes the UE to aggregate data at the UE for transmitting on a uplink (UL) from the UE to a base station communicating with the UE until a data aggregation condition is satisfied, determine when the data aggregation condition is satisfied at the UE, wherein the data aggregation condition includes at least a buffer occupancy condition or a delay transmission timer, and request resources from the base station for transmitting the data on the UL in response to determining that the data aggregation condition is satisfied.

Furthermore, in an aspect, the present disclosure presents an example apparatus for improving performance at a UE that may include a data aggregation component to aggregate data for transmitting on a uplink (UL) from the UE to a base station communicating with the UE until a data aggregation condition is satisfied, a data aggregation condition determining component to determine when a data aggregation condition is satisfied at the UE, wherein the data aggregation condition includes at least a buffer occupancy condition or a delay transmission timer, and a resource requesting component to request resources from the base station for transmitting the data on the UL in response to determining that the data aggregation condition is satisfied.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram illustrating an example wireless system in aspects of the present disclosure;

FIG. 2 is a flow diagram illustrating aspects of an example method in aspects of the present disclosure;

FIG. 3 is a block diagram illustrating an example performance manager in aspects of the present disclosure;

FIG. 4 is a block diagram illustrating aspects of a computer device according to the present disclosure;

FIG. 5 is a block diagram conceptually illustrating an example of a telecommunications system;

FIG. 6 is a conceptual diagram illustrating an example of an access network;

FIG. 7 is a conceptual diagram illustrating an example of a radio protocol architecture for the user and control plane; and

FIG. 8 is a block diagram conceptually illustrating an example of a NodeB in communication with a UE in a telecommunications system. FIG. 1 is a block diagram illustrating an example wireless system of aspects of the present disclosure;

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

The present disclosure provides a method and apparatus for improving performance at a user equipment (UE). For example, the method may include aggregating data in a buffer at the UE until a data aggregation condition is satisfied and then requesting resources from a base station for transmitting on a uplink (UL) from the UE to the base station, and transmitting the data on the UL once the resources are received from the base station.

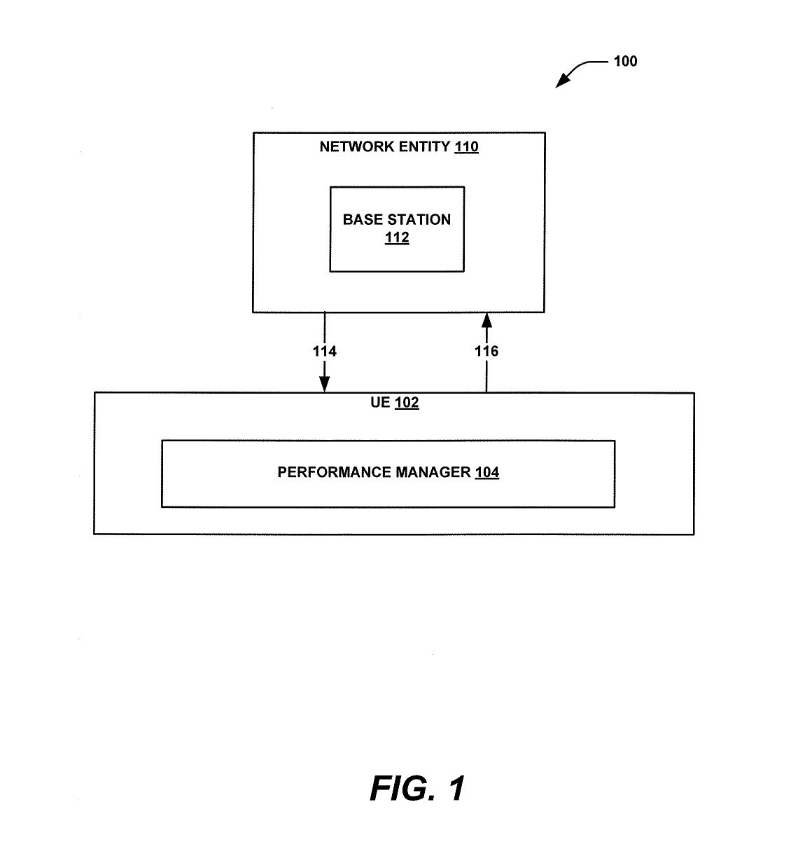

Referring to FIG. 1, a wireless communication system 100 is illustrated that facilitates improving performance at a user equipment (UE). For example, system 100 includes a UE 102 that may communicate with a network entity 110 via one or more over-the-air links 114 and/or 116. In an aspect, for example, network entity 110 may include a base station 112 that communicates with UE 102 on a downlink 114 and/or a uplink 116. A downlink (DL) is generally used for communication from the base station to the UE and the uplink (UL) is generally used for communication from the UE to the base station.

In an aspect, base station 112 may be configured with one or more cells for supporting communications with UE 102 and other UEs. In an additional aspect, a cell associated with base station 112 may be a serving cell of UE 102 (e.g., UE 102 is camped on a cell associated with base station 112).

In an aspect, network entity 110 may include one or more of any type of network components, for example, an access point, including a base station (BS) or Node B or eNodeB or a femto cell, a relay, a peer-to-peer device, an authentication, authorization and accounting (AAA) server, a mobile switching center (MSC), a radio network controller (RNC), etc., that can enable UE 102 to communicate and/or establish and maintain links 114 and/or 116 to communicate with network entity 110 and/or base station 112. In an additional aspect, for example, network entity 110 may operate according to a radio access technology (RAT) standard, e.g., GSM, CDMA, W-CDMA, HSPA or a LTE.

In an additional aspect, UE 102 may be a mobile apparatus and may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

In an aspect, when UE 102 has data to transfer on the UL (e.g., user of UE 102 has data to transfer on the UL), UE 102 may go through one or more state transitions before the UE can transmit data on the UL to base station 112. The UE may go through the state transitions without taking into consideration the amount of data to be transferred on the UL from UE 102 to base station 110 and/or cost of resources (e.g., processing power, bandwidth requirements, etc.) at UE 102 and/or base station 112. This may result in UE 102 going through the various state transitions for transmitting very small amounts of data, e.g., 50 bytes, on the UL from UE 102 to base station 112. This may impact performance of UE 102 in terms of, e.g., power, CPU, etc. Additionally, this may affect the performance of network entity 110 and/or base station 112 as a number of UEs (e.g., tens or hundreds) are supported by base station 112 and/or network entity 110. Further, if a number of background applications (e.g., applications that the user of the UE is not currently interacting with—weather, news, stock price, etc. applications) are running on the UE, a small amount of data may be generated periodically or continuously that may be related to synchronization of the UE with a server or some other network entity. Further, if UE 102 is involved in Machine to Machine (M2M) communications, the UE may be transmitting small amounts of data on a regular or continuous basis that may affect the performance of the system (e.g., UE 102, network entity 110, and/or base station 112).

In an aspect, UE 102 may include a performance manager 104 for improving performance of UE 102 by aggregating data at the UE for transmitting on a uplink (UL) from the UE to a base station until a data aggregation condition is satisfied, determining when the data aggregation condition is satisfied at the UE, wherein the data aggregation condition includes at least a buffer occupancy condition or a delay transmission timer, and requesting resources from the base station for transmitting the data on the UL in response to determining that the data aggregation condition is satisfied.

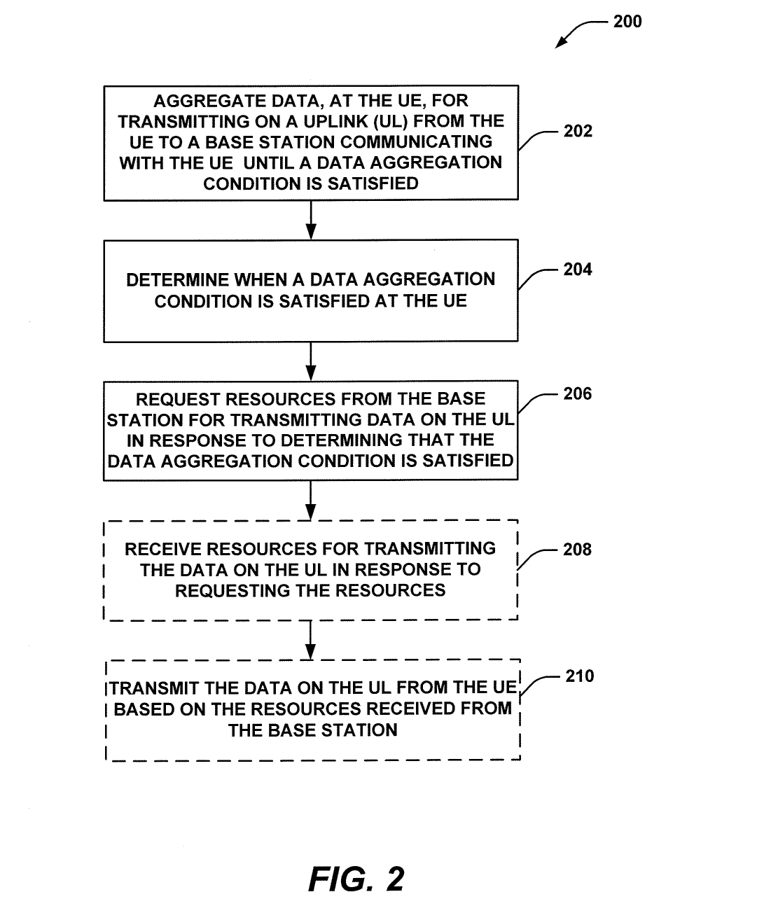

FIG. 2 illustrates an example methodology 200 for improving performance at a user equipment.

In an aspect, at block 202, methodology 200 may include aggregating data at the UE for transmitting on a uplink (UL) from the UE to a base station communicating with the UE. For example, in an aspect, UE 102 and/or performance manager 104 may include a specially programmed processor module, or a processor executing specially programmed code stored in a memory, to aggregate data at UE 102 for transmitting the data on a uplink (UL) (e.g., link 116) from UE 102 to base station 112.

In an aspect, the amount of data for transmitting from the UE on the UL may be relatively small, for example, 50 bytes in length. However, for UE 102 to transmit the data on the UL from UE 102 to base station 112, the UE has to go through several state transitions and/or procedures (e.g., requesting resources, setting or configuring the resources) prior to transmitting the data. But, the state transition and/or the procedures involved may consume scare and/or limited processing and/or bandwidth resources described above and may impact performance of UE 102 and/or base station 112. For example, in an aspect, UE 102 and/or performance manager 104 may have data for transmitting on the UL. UE 102, however, may have to transition to a state where UE 102 can request resources, e.g., HS-RACH resources, starting HS-RACH preamble or collision resolution process, etc., from network entity 110 and/or base station 112 which may be bandwidth (e.g., message) and/or processing power (e.g., CPU) intensive.

In an aspect, UE 102 and/or performance manager 104 may start aggregating data at UE 102 (e.g., in a buffer at UE 102, which may be called a data aggregation buffer) when UE 102 and/or performance manager 104 receives a request to transmit data on the UL (e.g., on UL 116) from UE 102 to base station 112. For example, the request to transmit data from UE 102 to base station 112 may be from an application running on UE 102 and the application may be an application that is running in the foreground (e.g., a new application launched by a user of the UE or an application a user on the UE is currently interacting with) or in the background (e.g. an application that may be always running but it's not the application the user on the UE is currently interacting with).

In an aspect, the size of the buffer may be configurable at the UE, and the performance manager 104 may continue aggregating data in the buffer until a data aggregation condition is satisfied as described below in detail.

In an aspect, at block 204, methodology 200 may include determining when a data aggregation condition is satisfied at the UE. For example, in an aspect, UE 102 and/or performance manager 104 may include a specially programmed processor module, or a processor executing specially programmed code stored in a memory, to determine when a data aggregation condition is satisfied at the UE. In an aspect, the data aggregation condition may include a buffer occupancy condition and/or a delay transmission timer.

UE 102 and/or performance manager 104 may aggregate data for transmitting on the UL until a data aggregation condition is satisfied. In an aspect, the data aggregation condition may include a buffer occupancy condition and/or a delay transmission timer. For example, a buffer occupancy condition may include buffering data for transmitting on the UL until a buffer occupancy value at the UE is above a threshold value. For example, UE 102 and/or performance manager 104 may buffer data until the buffer occupancy value is above a threshold value (e.g., buffer occupancy threshold value is set for 75% and buffer occupancy value is above 75% of the buffer capacity). In an additional aspect, the buffer occupancy threshold value at the UE is configurable and may be configured on a UE basis, UE type, UE version, base station basis, and/or network entity basis. This provides flexibility to a network operator where multiple versions of UEs with different capabilities and/or features are supported on the network.

For example, in an aspect, if the size of the buffer at the UE is 500 bytes and/or buffer occupancy threshold value is set at 75%, UE 102 and/or performance manager 104 aggregate data until the buffer occupancy is above 75%, e.g., at least 376 bytes of data is buffered at the UE. The data that is buffered is the data for transmitting from UE 102 on the UL to base station 112. As described above, this mechanism allows the UE to conserve processing resources at UE 102 and/or base station 112 and/or bandwidth resources on the UL and/or DL.

In an additional or optional aspect, the data aggregation condition may include a delay transmission timer. For example, a data aggregation condition that includes a delay transmission timer may include buffering data (e.g., storing data in a buffer at UE 102) for transmitting on the UL until a delay transmission timer at the UE is above a threshold value. For example, UE 102 and/or performance manager 104 may buffer data until the delay transmission timer value is above the threshold value (e.g., delay transmission timer is set at 100 ms). In an additional aspect, the delay transmission timer value may be configurable and may be configured on a UE basis, UE type, UE version, base station basis, and/or network entity basis for providing flexibility to a network operator where multiple versions of UEs with different capabilities and/or features are supported on the network.

For example, in an aspect, if the delay transmission timer is set or configured for 100 milliseconds (ms) at the UE, UE 102 and/or performance manager 104 aggregates data until the delay transmission timer is above 100 ms, e.g., at least 100 ms has passed since the UE has received a request for transmission of data on the UL from UE 102 to base station 112. That is, the data is buffered for transmitting from UE 102 on the UL to base station 112. As described above, this mechanism allows the UE to conserve processing resources at UE 102 and/or base station 112 and/or bandwidth on the UL and/or DL and may avoid or reduce scenarios where the UE may be waiting for too long before the data is transmitted on the UL from the UE to the base station. For example, if the data for transmitting on the UL from the UE to the base station is very small, for example, 10 bytes every 10 ms, the UE may have to wait for a long time (e.g., at least 375 ms) prior to the transmitting the data which may affect the performance of the UE.

In an additional aspect, the data aggregation condition may include a combination of buffer occupancy condition and a delay transmission timer may be used for improving performance at the UE. For example, in an aspect, a data aggregation condition may be satisfied if the buffer occupancy condition is above a first threshold value (e.g., buffer occupancy threshold value) and the delay transmission timer is above a second threshold value (e.g., delay transmission timer threshold value). For example, if the buffer occupancy condition is set to 75% and the delay transmission time is set for 100 ms, the data aggregation condition will be satisfied when both the conditions are met.

In an aspect, at block 206, methodology 200 may include requesting resources from the base station for transmitting the data on the UL in response to determining that the data aggregation condition is satisfied. For example, in an aspect, UE 102 and/or reselection manager 104 may include a specially programmed processor module, or a processor executing specially programmed code stored in a memory, to request resources from the base station (e.g., base station 112) for transmitting the data on the UL in response to determining that the data aggregation condition is satisfied. UE 102 and/or performance manager 104 may request resources (e.g., grants, codes, transmit (tx) power, etc.) from base station 112 once UE 102 and/or performance manager 104 determines that a buffer occupancy condition and/or a delay transmission timer are above their respective threshold values.

In an optional aspect, at block 208, methodology 200 may include receiving resources for transmitting the data on the UL in response to requesting the resources. For example, in an aspect, UE 102 and/or performance manager 104 may include a specially programmed processor module, or a processor executing specially programmed code stored in a memory, to receive resources for transmitting the data on the UL in response to requesting the resources. UE 102 and/or performance manager 104 may receive resources allocated by network entity and/or base station 112 to the UE based on the request from the UE once a data aggregation condition is satisfied.

In an optional aspect, at block 210, methodology 200 may include transmitting the data on the UL from the UE based on the resources received from the base station. For example, in an aspect, UE 102 and/or performance manager 104 may include a specially programmed processor module, or a processor executing specially programmed code stored in a memory, to transmit the data on the UL from the UE based on the resources received from the base station. The UE may use the resources received from base station 112 that may include grants, time slots, codes, etc. for transmitting data on the UL from UE 102 to base station 112.

In an additional or optional aspect, network entity 110 and/or the base station 112 may allocate a portion of the resources that were requested by the UE as the resources are generally shared with other UEs communication with the network entity and/or the base station. In such a scenario, the UE may transmit the data on the UL to the base station to the extent permitted based on the resource allocation to the UE, and the UE may continue buffering until a data aggregation condition is satisfied again. This may allow timely (e.g., efficient) transfer of the resources from the UE on the UL instead of waiting for all the requested resources to be granted at once prior to the transmitting of the data on the UL from the UE to the base station.

In an additional or optional aspect, prior to aggregating data, UE 102 and/or performance manager 104 may identify whether data for transmitting on the UL from the UE to the base station is delay sensitive. For example, the identifying may be based on whether data to be transmitted is associated with a priority message (e.g., signaling message), a priority application (e.g., E911 call), a voice call, and/or an application with a specific quality of service (QoS) requirement. For example, once UE 102 and/or performance manager 104 identifies that the data for transmitting on the UL is delay sensitive, as described above, UE 102 and/or performance manager 104 may transmit the data immediately without delay (e.g., delay associated with aggregating data until a data aggregation condition is satisfied) from the UE 102 to base station 112.

In an additional or optional aspect, UE102 and/or performance manager 104 may aggregate data without requesting for resources from network entity 110 to gain benefits associated with fewer transmissions from UE 102 to network entity 110. For example, in an aspect, there may be a default grant (e.g., common resources) available to UE on HS-RACH configured in R99 channels. In such an example scenario, when the UE is operating in a Release 99 environment, although UE 102 may not need any further commands from network entity 110, UE 102 may aggregate data for improving performance of UE 102, e.g., in terms of conserving battery power, etc.

Thus, as described above, improved performance at a UE by aggregating data may be achieved.

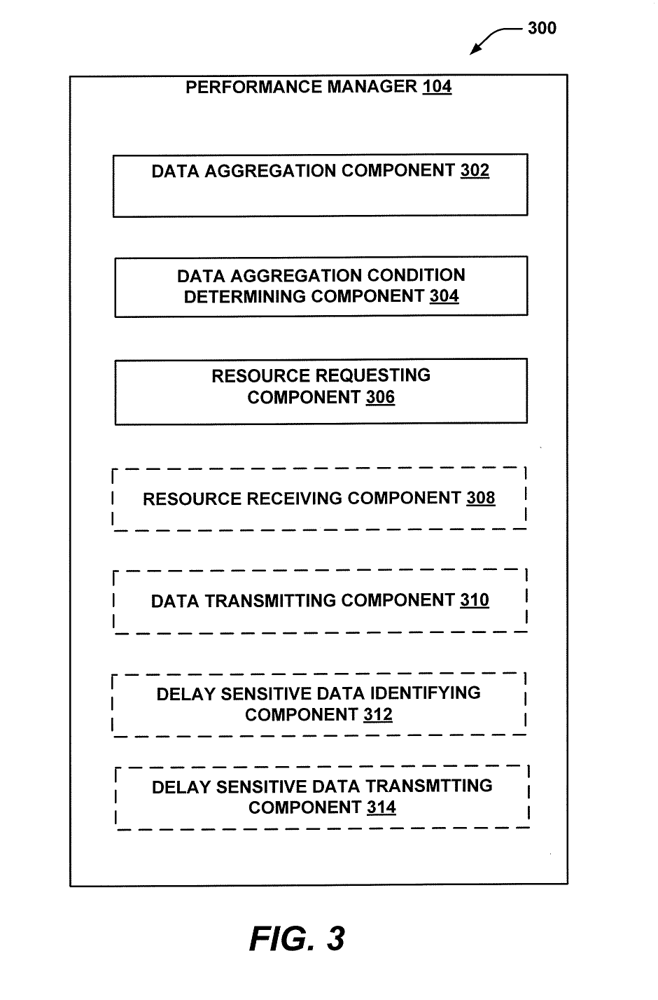

Referring to FIG. 3, illustrated are an example performance manager 104 and various sub-components for improving performance at a UE. In an example aspect, performance manager 104 may be configured to include the specially programmed processor module, or the processor executing specially programmed code stored in a memory, in the form of a data aggregation component 302, data aggregation condition determining component 304, and/or a resource requesting component 306. In an additional or an optional aspect, performance manager 104 may be configured to include a resource receiving component 308, a data transmitting component 310, delay sensitive data identifying component 312, and/or a delay sensitive data transmitting component 314. In an aspect, a component may be one of the parts that make up a system, may be hardware or software, and may be divided into other components.

In an aspect, performance manager 104 and/or data aggregation component 302 may be configured to aggregate data at the UE for transmitting on an uplink (UL) from the UE to a base station communicating with the UE. For example, in an aspect, data aggregation component 302 may be configured to aggregate data received at UE 102 for transmitting on the UL (e.g., 116) to base station 112. In an additional aspect, data aggregation component 302 may be configured to aggregate data until a data aggregation condition is satisfied.

In an aspect, performance manager 104 and/or data aggregation condition determining component 304 may be configured to determine when the data aggregation condition is satisfied at the UE. In an additional aspect, performance manager 104 and/or data aggregation condition determining component 304 may be configured to determine when the data aggregation condition is satisfied at UE 102 where the data aggregation condition includes a buffer occupancy condition and/or a delay transmission timer.

In an aspect, performance manager 104 and/or resource requesting component 306 may be configured to request resources from the base station for transmitting the data on the UL in response to determining that the data aggregation condition is satisfied. For example, in an aspect, resource requesting component 306 may be configured to request resources (e.g., grants, codes, tx power, etc.) from network entity 110 and/or base station 112.

In an optional aspect, performance manager 104 and/or resource receiving component 308 may be configured to receive resources for transmitting the data on the UL in response to requesting the resources. For example, in an aspect, resource receiving component 308 may be configured to receive resources (e.g., grants, codes, tx power, etc.) granted from/by network entity 110 and/or base station 112.

In an optional aspect, performance manager 104 and/or data transmitting component 310 may be configured to transmit the data on the UL from the UE based on the resources received from the base station. For example, in an aspect, data transmitting component 310 may be configured to transmit data (e.g., at least some of the data aggregated in the buffer) from the UE to base station 112.

In an optional aspect, performance manager 104 and/or delay sensitive data identifying component 312 may be configured to identify whether the data for transmitting on the UL is delay sensitive prior to aggregating the data. In an additional aspect, performance manager 104 and/or delay sensitive data transmitting component 314 may be configured to transmit the data without a delay when the data for transmitting is identified as delay sensitive, wherein the delay is related to aggregating of the data identified as delay sensitive.

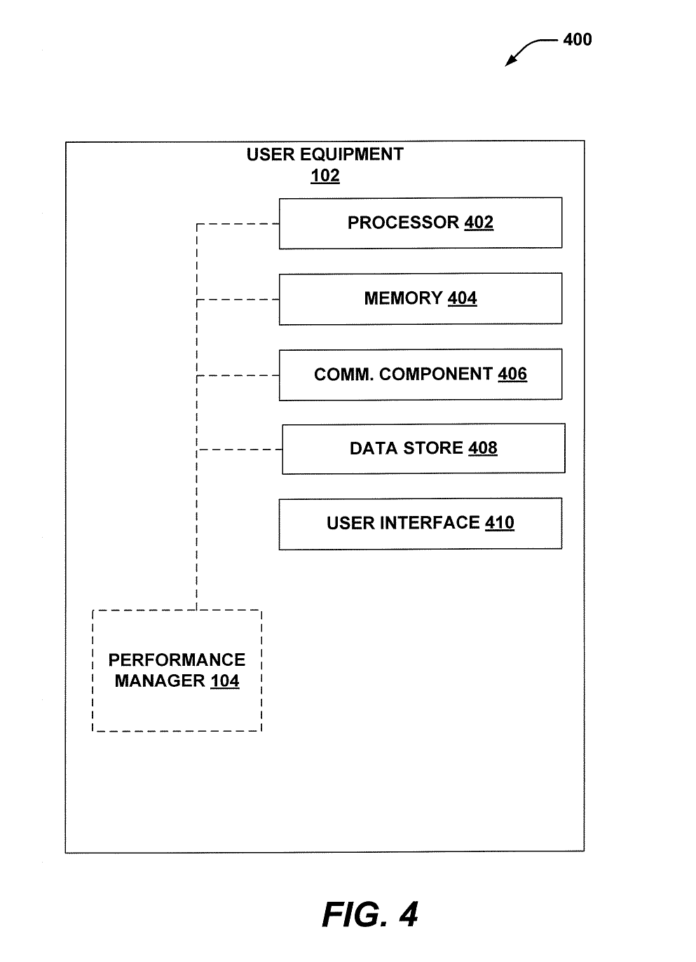

Referring to FIG. 4, in an aspect, UE 102, for example, including performance manager 104, may be or may include a specially programmed or configured computer device. In one aspect of implementation, UE 102 may include performance manager 104 and its sub-components, including data aggregation component 302, data aggregation condition determining component 304, resource requesting component 306, resource receiving component 308, data transmitting component 310, delay sensitive data identifying component 312, and/or delay sensitive data transmitting component 314, such as in specially programmed computer readable instructions or code, firmware, hardware, or some combination thereof.

In an aspect, for example as represented by the dashed lines, performance manager 104 may be implemented or executed using one or any combination of processor 402, memory 404, communications component 406, and data store 408. For example, performance manager 104 may be defined or otherwise programmed as one or more processor modules of processor 402. Further, for example, performance 104 may be defined as a computer-readable medium stored in memory 404 and/or data store 408 and executed by processor 402. Moreover, for example, inputs and outputs relating to operations of performance manager 104 may be provided or supported by communications component 406, which may provide a bus between the components of computer device 400 or an interface to communication with external devices or components.

UE 102 may include a processor 402 specially configured to carry out processing functions associated with one or more of components and functions described herein. Processor 402 can include a single or multiple set of processors or multi-core processors. Moreover, processor 402 can be implemented as an integrated processing system and/or a distributed processing system.

User equipment 102 further includes a memory 404, such as for storing data used herein and/or local versions of applications and/or instructions or code being executed by processor 402, such as to perform the respective functions of the respective entities described herein. Memory 404 can include any type of memory usable by a computer, such as random access memory (RAM), read only memory (ROM), tapes, magnetic discs, optical discs, volatile memory, non-volatile memory, and any combination thereof.

Further, user equipment 102 includes a communications component 406 that provides for establishing and maintaining communications with one or more parties utilizing hardware, software, and services as described herein. Communications component 406 may carry communications between components on user equipment 102, as well as between user and external devices, such as devices located across a communications network and/or devices serially or locally connected to user equipment 102. For example, communications component 406 may include one or more buses, and may further include transmit chain components and receive chain components associated with a transmitter and receiver, respectively, or a transceiver, operable for interfacing with external devices.

Additionally, user equipment 102 may further include a data store 408, which can be any suitable combination of hardware and/or software, that provides for mass storage of information, databases, and programs employed in connection with aspects described herein. For example, data store 408 may be a data repository for applications not currently being executed by processor 402.

User equipment 102 may additionally include a user interface component 410 operable to receive inputs from a user of user equipment 102, and further operable to generate outputs for presentation to the user. User interface component 410 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 410 may include one or more output devices, including but not limited to a display, a speaker, a haptic feedback mechanism, a printer, any other mechanism capable of presenting an output to a user, or any combination thereof.

The various concepts presented throughout this disclosure may be implemented across a broad variety of telecommunication systems, network architectures, and communication standards.

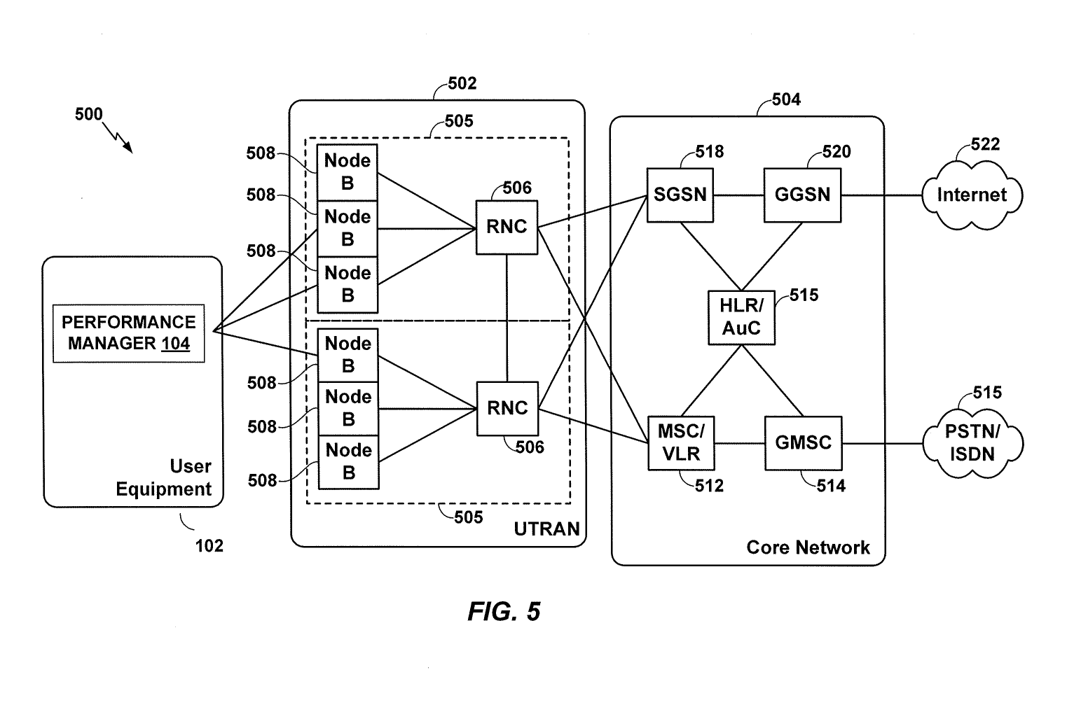

Referring to FIG. 5, by way of example and without limitation, the aspects of the present disclosure are presented with reference to a UMTS system 500 employing a W-CDMA air interface, and may include a UE 102 executing an aspect of performance manager 104 of FIGS. 1 and 3. A UMTS network includes three interacting domains: a Core Network (CN) 504, a UMTS Terrestrial Radio Access Network (UTRAN) 502, and UE 102. In an aspect, as noted, UE 102 (FIG. 1) may be configured to perform functions thereof, for example, including improving performance at a user equipment. Further, UTRAN 502 may comprise network entity 110 and/or base station 112 (FIG. 1), which in this case may be respective ones of the Node Bs 508. In this example, UTRAN 502 provides various wireless services including telephony, video, data, messaging, broadcasts, and/or other services. The UTRAN 502 may include a plurality of Radio Network Subsystems (RNSs) such as a RNS 505, each controlled by a respective Radio Network Controller (RNC) such as an RNC 506. Here, the UTRAN 502 may include any number of RNCs 506 and RNSs 505 in addition to the RNCs 506 and RNSs 505 illustrated herein. The RNC 506 is an apparatus responsible for, among other things, assigning, reconfiguring, and releasing radio resources within the RNS 505. The RNC 506 may be interconnected to other RNCs (not shown) in the UTRAN 502 through various types of interfaces such as a direct physical connection, a virtual network, or the like, using any suitable transport network.

Communication between UE 102 and Node B 508 may be considered as including a physical (PHY) layer and a medium access control (MAC) layer. Further, communication between UE 510 and RNC 506 by way of a respective Node B 508 may be considered as including a radio resource control (RRC) layer. In the instant specification, the PHY layer may be considered layer 1; the MAC layer may be considered layer 2; and the RRC layer may be considered layer 3. Information herein below utilizes terminology introduced in the RRC Protocol Specification, 3GPP TS 55.331 v5.1.0, incorporated herein by reference.

The geographic region covered by the RNS 505 may be divided into a number of cells, with a radio transceiver apparatus serving each cell. A radio transceiver apparatus is commonly referred to as a NodeB in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 508 are shown in each RNS 505; however, the RNSs 505 may include any number of wireless Node Bs. The Node Bs 508 provide wireless access points to a CN 504 for any number of mobile apparatuses, such as UE 102, and may be network entity 110 and/or base station 112 of FIG. 1. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus in this case is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

For illustrative purposes, one UE 102 is shown in communication with a number of the Node Bs 508. The DL, also called the forward link, refers to the communication link from a NodeB 508 to a UE 102 (e.g., link 114), and the UL, also called the reverse link, refers to the communication link from a UE 102 to a NodeB 508 (e.g., link 116).

The CN 504 interfaces with one or more access networks, such as the UTRAN 502. As shown, the CN 504 is a GSM core network. However, as those skilled in the art will recognize, the various concepts presented throughout this disclosure may be implemented in a RAN, or other suitable access network, to provide UEs with access to types of CNs other than GSM networks.

The CN 504 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 504 supports circuit-switched services with a MSC 512 and a GMSC 514. In some applications, the GMSC 514 may be referred to as a media gateway (MGW). One or more RNCs, such as the RNC 506, may be connected to the MSC 512. The MSC 512 is an apparatus that controls call setup, call routing, and UE mobility functions. The MSC 512 also includes a VLR that contains subscriber-related information for the duration that a UE is in the coverage area of the MSC 512. The GMSC 514 provides a gateway through the MSC 512 for the UE to access a circuit-switched network 516. The GMSC 514 includes a home location register (HLR) 515 containing subscriber data, such as the data reflecting the details of the services to which a particular user has subscribed. The HLR is also associated with an authentication center (AuC) that contains subscriber-specific authentication data. When a call is received for a particular UE, the GMSC 514 queries the HLR 515 to determine the UE's location and forwards the call to the particular MSC serving that location.

The CN 504 also supports packet-data services with a serving GPRS support node (SGSN) 518 and a gateway GPRS support node (GGSN) 520. GPRS, which stands for General Packet Radio Service, is designed to provide packet-data services at speeds higher than those available with standard circuit-switched data services. The GGSN 520 provides a connection for the UTRAN 502 to a packet-based network 522. The packet-based network 522 may be the Internet, a private data network, or some other suitable packet-based network. The primary function of the GGSN 520 is to provide the UEs 510 with packet-based network connectivity. Data packets may be transferred between the GGSN 520 and the UEs 102 through the SGSN 518, which performs primarily the same functions in the packet-based domain as the MSC 512 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a NodeB 508 and a UE 102. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 102 provides feedback to Node B 508 over the HS-DPCCH to indicate whether it correctly decoded a packet on the downlink.

HS-DPCCH further includes feedback signaling from the UE 102 to assist the Node B 508 in taking the right decision in terms of modulation and coding scheme and precoding weight selection, this feedback signaling including the CQI and PCI.

HSPA Evolved or HSPA+ is an evolution of the HSPA standard that includes MIMO and 64-QAM, enabling increased throughput and higher performance. That is, in an aspect of the disclosure, the Node B 508 and/or the UE 102 may have multiple antennas supporting MIMO technology. The use of MIMO technology enables the Node B 508 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 102 to increase the data rate or to multiple UEs 102 to increase the overall system capacity. This is achieved by spatially precoding each data stream and then transmitting each spatially precoded stream through a different transmit antenna on the downlink. The spatially precoded data streams arrive at the UE(s) 102 with different spatial signatures, which enables each of the UE(s) 102 to recover the one or more the data streams destined for that UE 102. On the uplink, each UE 102 may transmit one or more spatially precoded data streams, which enables Node B 508 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

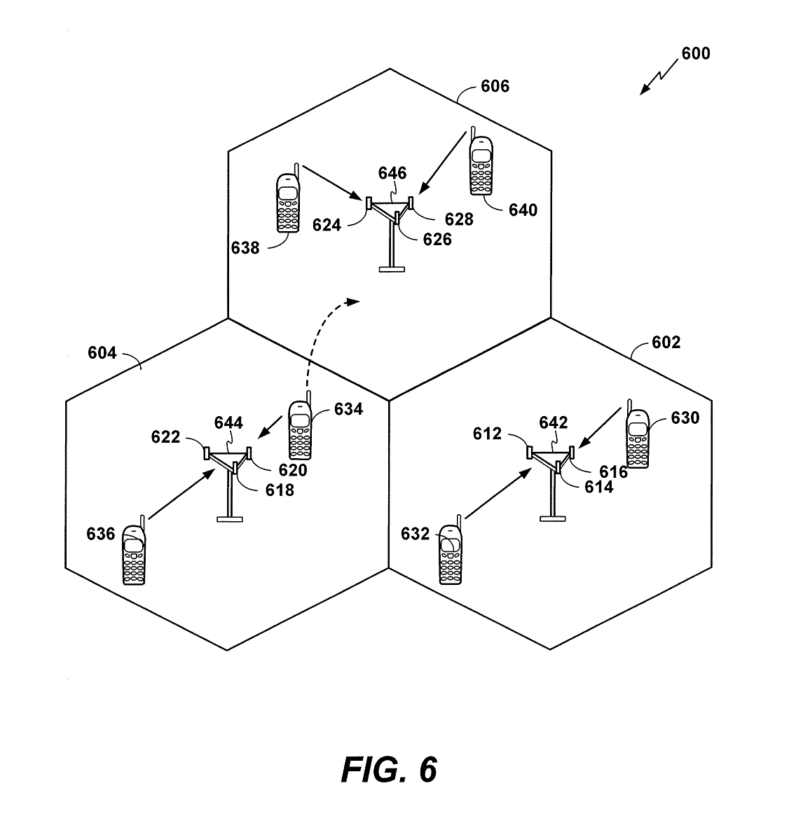

Referring to FIG. 6, an access network 600 in a UTRAN architecture is illustrated, and may include one or more UEs 630, 632, 634, 636, 630, 640, which may be the same as or similar to UE 102 (FIG. 1) in that they are configured to include performance manager 104 (FIG. 1) for improving performance at the user equipment (e.g., UE 102). The multiple access wireless communication system includes multiple cellular regions (cells), including cells 602, 604, and 606, each of which may include one or more sectors. The multiple sectors can be formed by groups of antennas with each antenna responsible for communication with UEs in a portion of the cell. For example, in cell 602, antenna groups 612, 614, and 616 may each correspond to a different sector. In cell 604, antenna groups 610, 620, and 622 each correspond to a different sector. In cell 606, antenna groups 624, 626, and 610 each correspond to a different sector. UEs, for example, 630, 632, etc. may include several wireless communication devices, e.g., User Equipment or UEs, including performance manager 104 of FIG. 1, which may be in communication with one or more sectors of each cell 602, 604 or 606. For example, UEs 630 and 632 may be in communication with NodeB 642, UEs 634 and 636 may be in communication with NodeB 644, and UEs 630 and 640 can be in communication with NodeB 646. Here, each NodeB 642, 644, 646 is configured to provide an access point to a CN 504 (FIG. 5) for all the UEs 630, 632, 634, 636, 630, 640 in the respective cells 602, 604, and 606. Additionally, each NodeB 642, 644, 646 may be base station 112 and/or and UEs 630, 632, 634, 636, 636, 640 may be UE 102 of FIG. 1 and may perform the methods outlined herein.

As the UE 634 moves from the illustrated location in cell 604 into cell 606, a serving cell change (SCC) or handover may occur in which communication with the UE 634 transitions from the cell 604, which may be referred to as the source cell, to cell 606, which may be referred to as the target cell. Management of the handover procedure may take place at the UE 634, at the Node Bs corresponding to the respective cells, at a radio network controller 506 (FIG. 5), or at another suitable node in the wireless network. For example, during a call with the source cell 604, or at any other time, the UE 634 may monitor various parameters of the source cell 604 as well as various parameters of neighboring cells such as cells 606 and 602. Further, depending on the quality of these parameters, the UE 634 may maintain communication with one or more of the neighboring cells. During this time, the UE 634 may maintain an Active Set, that is, a list of cells that the UE 634 is simultaneously connected to (i.e., the UTRA cells that are currently assigning a downlink dedicated physical channel DPCH or fractional downlink dedicated physical channel F-DPCH to the UE 634 may constitute the Active Set). In any case, UE 634 may execute reselection manager 64 to perform the reselection operations described herein.

Further, the modulation and multiple access scheme employed by the access network 600 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 1002.11 (Wi-Fi), IEEE 1002.16 (WiMAX), IEEE 1002.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

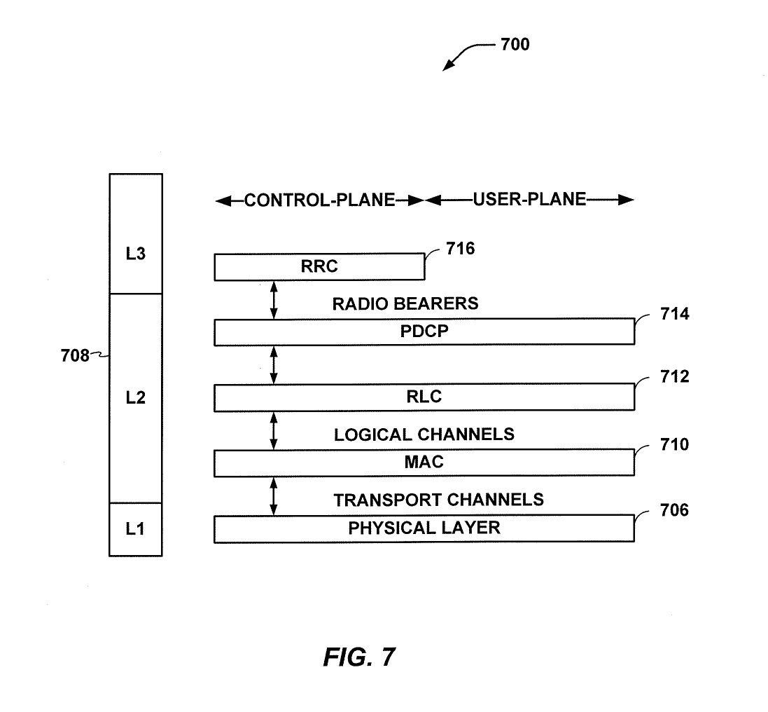

The radio protocol architecture may take on various forms depending on the particular application. An example for an HSPA system will now be presented with reference to FIG. 7. FIG. 7 is a conceptual diagram illustrating an example of the radio protocol architecture for the user and control planes.

Turning to FIG. 7, the radio protocol architecture for the UE, for example, UE 102 of FIG. 1 configured to include performance manager 104 (FIG. 1) for improving performance at the UE is shown with three layers: Layer 1, Layer 2, and Layer 3. Layer 1 is the lowest lower and implements various physical layer signal processing functions. Layer 1 will be referred to herein as the physical layer 706. Layer 2 (L2 layer) 708 is above the physical layer 706 and is responsible for the link between the UE and node B over the physical layer 706.

In the user plane, L2 layer 708 includes a media access control (MAC) sublayer 710, a radio link control (RLC) sublayer 712, and a packet data convergence protocol (PDCP) 714 sublayer, which are terminated at the node B on the network side. Although not shown, the UE may have several upper layers above L2 layer 708 including a network layer (e.g., IP layer) that is terminated at a PDN gateway on the network side, and an application layer that is terminated at the other end of the connection (e.g., far end UE, server, etc.).

The PDCP sublayer 714 provides multiplexing between different radio bearers and logical channels. The PDCP sublayer 714 also provides header compression for upper layer data packets to reduce radio transmission overhead, security by ciphering the data packets, and handover support for UEs between NodeBs. The RLC sublayer 712 provides segmentation and reassembly of upper layer data packets, retransmission of lost data packets, and reordering of data packets to compensate for out-of-order reception due to hybrid automatic repeat request (HARQ). The MAC sublayer 710 provides multiplexing between logical and transport channels. The MAC sublayer 710 is also responsible for allocating the various radio resources (e.g., resource blocks) in one cell among the UEs. The MAC sublayer 710 is also responsible for HARQ operations.

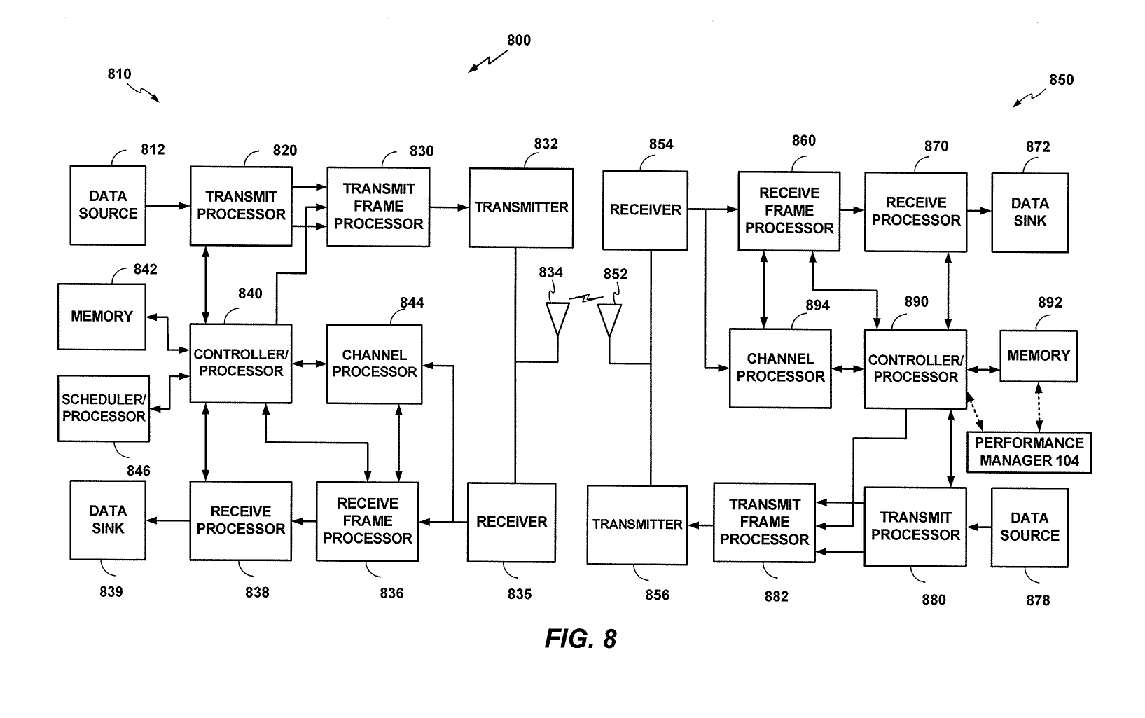

FIG. 8 is a block diagram of a NodeB 810 in communication with a UE 850, where the NodeB 810 may be base station 112 of network entity 110 and/or the UE 850 may be the same as or similar to UE 102 of FIG. 1 in that it is configured to include performance manager 104 (FIG. 1), for improving performance at the UE, in controller/processor 890 and/or memory 892. In the downlink communication, a transmit processor 820 may receive data from a data source 812 and control signals from a controller/processor 840. The transmit processor 820 provides various signal processing functions for the data and control signals, as well as reference signals (e.g., pilot signals). For example, the transmit processor 820 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 844 may be used by a controller/processor 840 to determine the coding, modulation, spreading, and/or scrambling schemes for the transmit processor 820. These channel estimates may be derived from a reference signal transmitted by the UE 850 or from feedback from the UE 850. The symbols generated by the transmit processor 820 are provided to a transmit frame processor 830 to create a frame structure. The transmit frame processor 830 creates this frame structure by multiplexing the symbols with information from the controller/processor 840, resulting in a series of frames. The frames are then provided to a transmitter 832, which provides various signal conditioning functions including amplifying, filtering, and modulating the frames onto a carrier for downlink transmission over the wireless medium through antenna 834. The antenna 834 may include one or more antennas, for example, including beam steering bidirectional adaptive antenna arrays or other similar beam technologies.

At the UE 850, a receiver 854 receives the downlink transmission through an antenna 852 and processes the transmission to recover the information modulated onto the carrier. The information recovered by the receiver 854 is provided to a receive frame processor 860, which parses each frame, and provides information from the frames to a channel processor 894 and the data, control, and reference signals to a receive processor 850. The receive processor 850 then performs the inverse of the processing performed by the transmit processor 820 in the NodeB 88. More specifically, the receive processor 850 descrambles and de-spreads the symbols, and then determines the most likely signal constellation points transmitted by the NodeB 88 based on the modulation scheme. These soft decisions may be based on channel estimates computed by the channel processor 894. The soft decisions are then decoded and de-interleaved to recover the data, control, and reference signals. The CRC codes are then checked to determine whether the frames were successfully decoded. The data carried by the successfully decoded frames will then be provided to a data sink 852, which represents applications running in the UE 850 and/or various user interfaces (e.g., display). Control signals carried by successfully decoded frames will be provided to a controller/processor 890. When frames are unsuccessfully decoded by the receiver processor 850, the controller/processor 890 may also use an acknowledgement (ACK) and/or negative acknowledgement (NACK) protocol to support retransmission requests for those frames.

In the uplink, data from a data source 858 and control signals from the controller/processor 890 are provided to a transmit processor 880. The data source 858 may represent applications running in the UE 850 and various user interfaces (e.g., keyboard). Similar to the functionality described in connection with the downlink transmission by the NodeB 810, the transmit processor 880 provides various signal processing functions including CRC codes, coding and interleaving to facilitate FEC, mapping to signal constellations, spreading with OVSFs, and scrambling to produce a series of symbols. Channel estimates, derived by the channel processor 894 from a reference signal transmitted by the NodeB 88 or from feedback contained in the midamble transmitted by the NodeB 810, may be used to select the appropriate coding, modulation, spreading, and/or scrambling schemes. The symbols produced by the transmit processor 880 will be provided to a transmit frame processor 882 to create a frame structure. The transmit frame processor 882 creates this frame structure by multiplexing the symbols with information from the controller/processor 890, resulting in a series of frames. The frames are then provided to a transmitter 856, which provides various signal conditioning functions including amplification, filtering, and modulating the frames onto a carrier for uplink transmission over the wireless medium through the antenna 852.

The uplink transmission is processed at the NodeB 810 in a manner similar to that described in connection with the receiver function at the UE 850. A receiver 835 receives the uplink transmission through the antenna 834 and processes the transmission to recover the information modulated onto the carrier. The information recovered by the receiver 835 is provided to a receive frame processor 836, which parses each frame, and provides information from the frames to the channel processor 844 and the data, control, and reference signals to a receive processor 838. The receive processor 838 performs the inverse of the processing performed by the transmit processor 880 in the UE 850. The data and control signals carried by the successfully decoded frames may then be provided to a data sink 839 and the controller/processor, respectively. If some of the frames were unsuccessfully decoded by the receive processor, the controller/processor 840 may also use an acknowledgement (ACK) and/or negative acknowledgement (NACK) protocol to support retransmission requests for those frames.

The controller/processors 840 and 890 may be used to direct the operation at the NodeB 810 and the UE 850, respectively. For example, the controller/processors 840 and 890 may provide various functions including timing, peripheral interfaces, voltage regulation, power management, and other control functions. The computer readable media of memories 842 and 892 may store data and software for the NodeB 810 and the UE 850, respectively. A scheduler/processor 846 at the NodeB 88 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for improving performance at a user equipment (UE), comprising:
aggregating data, at the UE, for transmitting on a uplink (UL) from the UE to a base station communicating with the UE until a data aggregation condition is satisfied;
determining when the data aggregation condition is satisfied at the UE, wherein the data aggregation condition includes at least a buffer occupancy condition or a delay transmission timer; and
requesting resources from the base station for transmitting the data on the UL in response to determining that the data aggregation condition is satisfied.

2. The method of claim 1, wherein determining when the data aggregation condition is satisfied comprises:
identifying whether a buffer occupancy value associated with the buffer occupancy condition is above a first threshold value, wherein the first threshold value is configurable.

3. The method of claim 1, wherein determining when the data aggregation condition is satisfied comprises:
identifying whether a timer value associated with receiving an initial request for transmitting data on the UL is above a second threshold value, wherein the second threshold value is configurable.

4. The method of claim 1, further comprising:
receiving resources for transmitting the data on the UL in response to requesting the resources; and
transmitting the data on the UL from the UE based on the resources received from the base station.

5. The method of claim 1, further comprising:
identifying whether the data for transmitting on the UL is delay sensitive prior to aggregating the data; and
transmitting the data without a delay when the data for transmitting is identified as delay sensitive, wherein the delay is related to aggregating of the data identified as delay sensitive.

6. The method of claim 1, wherein identifying whether the data for transmitting is delay sensitive comprises determining whether the data is associated with at least a priority message, a priority application, or an application with a specific quality of service (QoS) requirement.

7. An apparatus for improving performance at a user equipment (UE), comprising:
means for aggregating data, at the UE, for transmitting on a uplink (UL) from the UE to a base station communicating with the UE until a data aggregation condition is satisfied;
means for determining when a data aggregation condition is satisfied at the UE, wherein the data aggregation condition includes at least a buffer occupancy condition or a delay transmission timer; and
means for requesting resources from the base station for transmitting the data on the UL in response to determining that the data aggregation condition is satisfied.

8. The apparatus of claim 7, wherein means for determining when the data aggregation condition is satisfied comprises:
means for identifying whether a buffer occupancy value associated with the buffer occupancy condition is above a first threshold value, wherein the first threshold value is configurable.

9. The apparatus of claim 7, wherein means for determining when the data aggregation condition is satisfied comprises:
means for identifying whether a timer value associated with receiving an initial request for transmitting data on the UL is above a second threshold value, wherein the second threshold value is configurable.

10. The apparatus of claim 7, further comprising:
means for receiving resources for transmitting the data on the UL in response to requesting the resources; and
means for transmitting the data on the UL from the UE based on the resources received from the base station.

11. The apparatus of claim 7, further comprising:
means for identifying whether the data for transmitting on the UL is delay sensitive prior to aggregating the data; and
means for transmitting the data without delay when the data for transmitting is identified as delay sensitive, wherein the delay is related to aggregating of the data identified as delay sensitive.

12. The apparatus of claim 1, wherein means for identifying whether the data for transmitting is delay sensitive comprises means for identifying whether the data is associated with at least a priority message, a priority application, or an application with a specific quality of service (QoS) requirement.

13. An apparatus for improving performance at a user equipment (UE), comprising:
a data aggregation component to aggregate data for transmitting on a uplink (UL) from the UE to a base station communicating with the UE until a data aggregation condition is satisfied;
a data aggregation condition determining component to determine when a data aggregation condition is satisfied at the UE, wherein the data aggregation condition includes at least a buffer occupancy condition or a delay transmission timer; and
a resource requesting component to request resources from the base station for transmitting the data on the UL in response to determining that the data aggregation condition is satisfied.

14. The apparatus of claim 13, wherein the data aggregation condition determining component is further configured to identify whether a buffer occupancy value associated with the buffer occupancy condition is above a first threshold value, wherein the first threshold value is configurable.

15. The apparatus of claim 13, wherein the data aggregation condition determining component is further configured to identify whether a timer value associated with receiving an initial request for transmitting data on the UL is above a second threshold value, wherein the second threshold value is configurable.

16. The apparatus of claim 13, further comprising:
a resource receiving component to receive resources for transmitting the data on the UL in response to requesting the resources; and
a data transmission component to transmit the data on the UL from the UE based on the resources received from the base station.

17. The apparatus of claim 13, further comprising:
a delay sensitive data identifying component to identify whether the data for transmitting on the UL is delay sensitive prior to aggregating the data; and
a delay sensitive data transmitting component to transmit the data without a delay when the data for transmitting is identified as delay sensitive, wherein the delay is related to aggregating of the data identified as delay sensitive.

18. The apparatus of claim 17, wherein the delay sensitive data identifying component is further configured to identify whether the data for transmission is delay sensitive based on whether the data is associated with at least a priority message, a priority application, or an application with a specific quality of service (QoS) requirement.
